(19) United States
(12) Patent Application Publication
(10) Pub. No.: US 2023/0186359 A1
(43) Pub. Date: Jun. 15, 2023

(54) SYSTEM AND METHOD FOR TRACKING DISSEMINATION OF AN ACQUISITION OPPORTUNITY

(71) Applicant: Benjamin Gerut, New York, NY (US)

(72) Inventor: Benjamin Gerut, New York, NY (US)

(21) Appl. No.: 18/046,918

(22) Filed: Oct. 15, 2022

Related U.S. Application Data
(60) Provisional application No. 63/255,954, filed on Oct. 15, 2021.

(51) Int. Cl. G06Q 30/0601

(52) U.S. Cl. CPC G06Q 30/0611

(57) ABSTRACT

A system and method for tracking the dissemination of an unusual opportunity when searching for an ideal acquirer, and elucidating the most valuable members of a dissemination network. An originator prepares an accurate description of the opportunity and necessary qualities of a suitable acquirer of that opportunity. That description is transformed into a digital object presented on a webpage. A hyperlink, QR code or similar code is generated for the webpage, and is disseminated to one or more persons believed to either be a suitable acquirer for the opportunity or two be likely to know others who are suitable for the opportunity. The recipients of the hyperlink or QR code may present an offer to acquire the opportunity or may forward the opportunity to one or more additional, subsequent recipients. This process continues until a suitable person is found to acquire the opportunity.

### CROSS-REFERENCE TO RELATED APPLICATIONS

This application claims priority to U.S. Provisional Application Ser. No. 63/255,954 filed on Oct. 15, 2021.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to a mapping of a nodal network “tree” formed by creating connections between an opportunity and an acquirer. More particularly, the invention relates to methods of matching opportunities to acquirers by providing a scalable and data-secure method of distributing said opportunities through an extant network of potential acquirers and their real-world relationships.

### Description of the Related Art

One of the oldest challenges in society is connecting sellers of rare, esoteric or unusual products, information or services with suitable providers or purchasers of those services or items. This is not a problem for general commodities, products, or fungible goods mass-produced for large groups of consumers. There are, however, numerous products, data sets, and/or services that are extremely rare, only desired or possessed by a relatively few number of people. For example, rare works of art have a limited audience of purchasers who can both afford the artwork and appreciate a particular work's aesthetic value. There is also typically a very limited number of persons interested in purchasing unusual businesses or unusual business opportunities. Providing esoteric or not widely known information to a seeker of said information represents a similar problem, as does finding a service provider who can perform a task which requires highly specialized skill or knowledge.

Both providers and acquirers of unusual opportunities can have great difficulty in locating one another. It is generally not practical for the provider of an opportunity to engage in a wide reaching, expensive advertising campaign. Such opportunities are also not amenable to open marketplaces (even when partially specialized) such as Amazon®, Etsy® or Ebay®. It is thus challenging to find the most ideal candidate for rare and/or esoteric opportunities.

In addition, persons interested in acquiring unusual opportunities are understandably wary; the markets for rare and unusual items are rife with fraud or inaccuracy. Acquirers of rare commodities are often only interested if the opportunity is introduced to him or her through a trusted member of his or her specialized network within the domain of that opportunity. Esoteric and unusual opportunities can also be connected to each other through specialized brokers, various specialty groups or networks, and/or auctions. Several organizations promote themselves as networks of people or businesses having similar interests. However, identifying the most appropriate auction, best connected broker, or most effective network can be challenging.

Furthermore, brokers of unusual, esoteric or unique opportunities can charge high or excessive rates for their services. A highly unusual opportunity may pass through several brokers, each adding a fee to the overall price. Purchasers generally do not know how much of the price consists of brokerage fees, and brokers generally have little or no incentive to minimize their fees given a lack of broad and active competition for the brokerage of such opportunities.

The problem of pairing an esoteric and/or unique opportunity with the most ideal and most interested acquirer is not limited to opportunities for purchasing rare products or engaging in unusual or rare business ventures. There are many more mundane examples. Businesses sometimes look for employees having highly specialized skills and/or various unique qualities. Online platforms such as Indeed® and Monster® provide large pools of prospective employees, but an employer is required to sift through thousands of resumes using mediocre or in adequate search tools. Furthermore, specialty marketplace (such as those listed above) often do not provide adequate flexibility in how prospects represent themselves in order to properly accommodate the unique, specialized or esoteric candidate or opportunity.

In a more personal setting, persons often spend years searching for the ideal spouse. Match® and eHarmony® provide relatively large databases but matching algorithms and search tools are generally incapable of accurately identifying an ideal romantic partner. Some of these matchmaking platforms, e.g. eHarmony® already utilize sophisticated algorithms to assist its clients in identifying good matches between profiles. However, most of these types of algorithms are not efficient and users of these platforms must still spend a substantial amount of time sifting through profiles before finding well-suited prospective candidates. Perhaps more problematically, said algorithms will often exclude prospects which may have been appropriate matches.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide systems and methods for connecting opportunities to well-suited acquirers. It is also desirable to minimize the cost of connecting an opportunity to an acquirer.

### BRIEF SUMMARY OF THE INVENTION

Disclosed is a novel method of matching opportunities to acquirers by providing a scalable and data-secure method of distributing said opportunities through an extant network of potential acquirers and their real-world relationships.

The system allows an originator of an opportunity to migrate and represent the opportunity digitally and distribute the opportunity to a set of potential acquirers via a URL link, QR code, or other method of routing or linking back to the digital object which presents the relevant details of the opportunity. The digital object may contain information about the originator, or only the opportunity.

The first-order recipients then have the option of either pursuing the opportunity directly as prospective acquirors which will lead to an originator selected identification and verification process, or forwarding/resharing the opportunity with their own set of unique recipients/potential acquirers via the same method as the originator but where the system generates a new link back to the digital object but which is unique to that sender.

In this way, the system is constantly assembling and maintaining the branches of the network “tree” originating with the sender and scaling to all N-order recipients. This process can continue endlessly. Any recipient has the ability to either pursue or forward the opportunity unless otherwise restricted by the originator. A recipient who is interested in pursuit indicates his interest to the originator and provides certain identification, bid, or other information to the originator as selected by the originator. If the originator accepts the recipient's interest, originator identity may be revealed and the negotiation continue either via system software or across other media.

The system may be utilized in replacement of status quo marketplace and matching systems like auctions sites, job sites, or dating apps, but can also be utilized for more ad hoc or one-off purposes which may not fit tightly into the purpose of an existing marketplace platform, such as highly specialized equipment or asset sale, esoteric information requests, geographically or demographically restricted opportunities, and the like.

The system will also support economic, reputational or other value incentive for the network participants, so that each recipient can receive value for resharing an opportunity thereby providing incentive to continue to propagate the “tree branch.”

In one embodiment, the method for tracking dissemination of an acquisition opportunity comprises an originator creating a first digital object describing an opportunity available for acquisition, and minimum requirements for an acceptable offer. An online platform generates a first webpage displaying the first digital object, and provides a viewer with an offer submission option and an opportunity forwarding option. The platform then provides the originator with a first link to the first webpage, and associates the originator with the first digital object, the first webpage and the link. The originator then disseminates the link to one or more first-tier recipients. The first-tier recipients view the first webpage, and the platform records viewing data for the first webpage. When one of the first-tier recipients selects the offer submission option, the platform requests information and transmits an offer including the submitted offeror information to the originator.

When one of the one or more first-tier recipients selects the opportunity forwarding option, the platform requests a connection value from the first-tier recipient. The platform then generates a second digital object by combining the first digital object and the connection value submitted by the first-tier recipient, and second webpage associated with the first-tier recipient, which displays the second digital object. The second webpage also includes a second offer submission option and a second opportunity forwarding option. The platform also provides the first-tier recipient with a second link to the second webpage and associates the second digital object, the second webpage, and the second link with the first-tier recipient. The first-tier recipient disseminates the second link to one or more second-tier recipients, and the platform associates a total number of viewers of the second webpage with the first-tier recipient that selected the opportunity forwarding option. This process is repeated until the originator accepts a submitted offer. For each recipient, the platform recording and ranking a total number of views of all digital objects which include each recipient's connection value.

In another embodiment, the method for tracking dissemination of an acquisition opportunity ranks recipients according to the number of times an offer is submitted and accepted for any digital object which includes that recipient's connection value. The platform may optionally generate a recipient database, and rank recipients according to the total views attributable to each recipient, the total accepted offers attributable to each recipient, and/or connection value. The recipients may be categorized based on types of opportunities.

In another embodiment, the links to webpages are disseminated by the platform itself, upon an originator or recipient providing email addresses, phone numbers or other means of identifying subsequent recipients. The types of opportunities used with the invention may include a business for sale, a type of business which the originator wishes to acquire, an artwork for sale, and an artwork which the originator wishes to acquire. The originator may remain anonymous until an offer is accepted. The method may also require the originator to approve any connection values entered by a recipient. When connection values are added to a digital object, they may or may not be itemized. The method also includes the construction of a nodal tree showing the connections between each recipient and the originator.

It is therefore an object of the present invention to provide a secure, scalable method of rapidly and efficiently distributing information regarding a rare opportunity to the maximum number of prospective acquirers while also creating strong incentives to minimize the time, effort and other costs associated with connecting the opportunity to the acquirer.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a flowchart of a method for tracking dissemination of an acquisition opportunity in accordance with the principles of the invention;

FIG. 2 is a nodal tree constructed using a method for tracking dissemination of an acquisition opportunity in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Disclosed is a system and method for rapidly and broadly disseminating information regarding an opportunity throughout one or more networks of prospective acquirers while also minimizing the cost of connecting the opportunity to an acquirer.

The systems and methods disclosed herein are suitable for a wide variety of uncommon or unique opportunities. Such opportunities may take a variety of forms. For example, an opportunity may be a business for sale. There are many highly specialized businesses that can only be adequately managed by persons having highly specialized skill sets, networks and/or resources. Securities, such as esoteric or bonds or other structured equity in the specialized businesses are also only desired by relatively small subsets of possible purchasers. Another exemplary opportunity may be a person with very rare but valuable skills seeking employment. Conversely an opportunity may also be an employment opening at a business that is suitable only for an employee having very specialized sets of skills or experience. An opportunity may also be a friend or relative who has experienced unique difficulty in finding a suitable romantic partner or spouse. But an opportunity may also present in the form of a willingness to be compensated or to compensate for certain esoteric information or service.

The systems and methods disclosed herein begin with an originator creating digital object that identifies and describes an opportunity. The originator may be the owner of a rare item, the provider of a rare service, a person or business aware of a rare business opportunity, such as for example a company looking for a business partner for a new venture or an employer looking for specialized employees, or even a friend of a person seeking a spouse or romantic partner. The originator is a person or business who can accurately describe the opportunity and who knows one or more prospective acquirers (or parties who may know prospective acquirors) of the opportunity. Prospective acquirers are generally persons or businesses that may either be interested in the opportunity itself, or may know others who are interested, or may know others, in such an opportunity.

The digital object created by the originator provides a description of the opportunity. In one embodiment, the originator uses a system, software or platform to generate a customizable digital object. A digital object can include one or more of written descriptions, images, video files, audio files, and bid or ask information. The digital may or may not contain information about the originator but only information relating to the opportunity itself. The digital object may reside within an software application which collects customizable data from and relating to anyone who attempts to view the digital object and/or pursue the opportunity it represents. The data collected may be stored and analyzed by the system and/or provided to the originator or participants in the network branch or tree in certain instances. In some embodiments, the digital object can only be viewed after the viewer accepts terms of service determined by the system and/or originator.

A webpage or application displaying the digital object and a link to the webpage is generated by the system. The webpage also includes a button, or link, that a viewer of the digital object may use to prepare and send an expression of interest in acquiring the opportunity. When this button is actuated, the system may request additional information from the viewer of the digital object. This additional information is then provided to the originator.

The originator can determine the scope of the additional information requested from a viewer of the digital object who wishes pursue the opportunity. Generally this additional information would include the identity of the person pursuing, financial or other information demonstrating that they are able to acquire the opportunity (or deliver the service), and additional information demonstrating that the person has the skills or other criteria required to acquire, exploit and/or take advantage of the opportunity. Such additional information is in the nature of a preliminary due diligence inquiry. The additional information may then be used by the originator to determine whether to accept the offer made to acquire the opportunity and discontinue further dissemination of the opportunity through other prospective acquirers. At any time, the originator may withdraw the opportunity thereby rendering a links to the digital object to default to a message notifying attempting viewers of the object of the opportunity's termination.

By way of example, an opportunity may be a business for sale. The originator may wish to screen persons offering to buy the business, to ensure that the purchaser has the correct skills and business knowledge to make the business profitable.

As an alternative example, the opportunity may be a single person in search of a possible spouse. The digital object may be a profile, or description of the person interested in a relationship. The offer requirement identified by the originator may include a prospective spouse's religion, political views, education, employment history, desire to have children, and the like. The digital object is created by the originator, for example by using an online platform with a digital object creation wizard. The digital object is displayed on a unique website created by the platform for the originator. The webpage includes a button or link which may be actuated to submit an offer to meet with the single person. The originator then sends the link to recipients that may be a suitable match for the single person. The recipient, may become an offeror by actuating the “submit offer” button. The offeror must then provide information so that the originator can determine whether the offeror meets the offer requirements, i.e. criteria, deemed important to making a successful romantic match. If the recipient does not wish to make an offer, he or she can actuate a “forward button” on the webpage to generate a new digital object, a new webpage and a new link to the new webpage. The recipient then sends the link the other recipients who may be interested in the opportunity. The forwarding recipient can add a “connection value” to his or her newly generated digital object. The connection value can be almost anything, from a monetary payment, similar to a finder's fee, or answers to certain questions which the recipient believes are important to finding a suitable match.

The forwarding button, or link, through which a viewer of the digital object, i.e. a prospective acquirer or recipient, may forward the digital object to other prospective acquirers who may be interested in the opportunity. When this button is actuated, the system may request additional information from the viewing recipient, such as their identity, contact information, and required compensation. The system will then generate a new, unique link, specific to the viewer, to the same webpage or otherwise represented digital object. The viewer may then distribute his or her unique link to additional persons. This process repeats itself indefinitely, disseminating the opportunity throughout a network of prospective acquirers. Prospective acquirers who receive a link to the webpage from the originator are referred to as first tier or first order recipients. Prospective acquirers who receive a link to the webpage from first tier recipients are referred to as second-tier recipients, and so on. All of the prospective acquirers beyond the first tier recipients are collectively referred to herein as subsequent recipients. When and if any of the subsequent recipients choose to extend an offer to the originator to acquire the opportunity described in the digital object, then any such subsequent recipient would provide the additional information to the originator.

This process of the first tier recipients and subsequent recipients continuing to disseminate the link to the digital objects until a suitable match is found who is capable of taking maximum advantage of the opportunity may continue as long as desired by the originator. The system generates a new link to the digital object for each recipient who elects to forward the digital object to additional, subsequent recipients, each of whom may attach their own requirements for women if the originator accepts an offer from a subsequent recipient further down the chain. These requirements will often take the form of a referral fee or finder's fee. However, other requirements may also be elected, including but not limited to requirements to share information, rights of first refusal for new products developed, and/or designating a forwarding recipient as a vendor or customer regarding one or more aspects of the opportunity. The requirements attached to the opportunity facilitated by a particular recipient can be referred to as the “connection value” for that recipient. As the link to the digital object is passed through subsequent recipients, these connection values are summed and, when possible, compressed. The more connections between recipients required prior to finding a suitable match for the opportunity, the more requirements, or connection values, are attached. The connection values themselves are not added to the digital object itself. However, the originator may be made aware of each of the connection values and may optionally have the ability to reject any unsuitable connection value, or put limitations of allowable connection values in size or type prior to the launching of the opportunity.

Those skilled in the art will appreciate that the system and methods of the present invention will naturally form a nodal tree structure, with each of the recipients serving as a node in a one or more branches of the nodal tree. In the case of a very unique or very esoteric opportunity, the branches of the nodal tree may be extensive. Each of the recipients of the digital object may optionally be given the option to disable the forwarding option of the digital object for the subsequent recipients to which the digital object is forwarded. This effectively snips or terminated those particular branches of the nodal treat. A branch may be snipped for three reasons: (1) the originator terminates the opportunity, (2) the connection values exceed marketplace tolerance and forwarding ceases, or (3) forwarding limitations by one or more recipients leads to inability for a subsequent recipient to forward the opportunity.

Furthermore, there is always the possibility that two separate recipients will forward the opportunity to the same new subsequent recipients. The systems and methods of the present invention turns this into an advantage. In the case where a subsequent recipient wishes to pursue or extend an offer to the originator and has the choice of pursuing through one of two or more branches in the nodal tree, that recipient and/or the originator may designate which branch for the opportunity to flow through. For example, a new subsequent recipient may receive the link to the digital object from a second-tier recipient and from a seventh-tier recipient, simultaneously (in advance of pursuing either). Because each recipient in a chain may attach one or more connection value or other requirements, the chain through the second-tier recipient will likely be less restrictive and therefore more desirable to both the originator and the final recipient making the offer. In that case, the final recipient and the originator may elect that shorter branch. Alternatively, the second-tier recipient may have attached a particularly onerous connection value, for example a particularly high finder's fee. If either the originator or the final recipient extending the offer determines that the connection value from the second recipient is less desirable than the combined requirements, or connection values, found in the nodal branch extending through the seventh-tier recipients, then the originator and/or the final recipients may choose to utilize the branch extending through the seventh recipients. The ability of the systems and methods of the present invention to provide this option of selecting the most optimal branch through a nodal tree provides synergistic advantages to both the originator and a recipient extending an offer to acquire the opportunity. It allows an originator to quickly and efficiently disseminate the availability of the opportunity throughout a broad network. It also allows an originator to identify a suitable entity for acquiring the opportunity through more than one channel, i.e. branch in the nodal tree. It also incentivizes any recipients that forward notice of the opportunity onto subsequent recipients to minimize the requirements, i.e. the connection values, they attach to the opportunity, because doing so makes their branch more competitive with other branches and generally maintains a lower all-in cost in the mind of the acquirer relative to other unrelated opportunities. Recipients forwarding the digital object will be cognizant of the fact that an ultimate acquirer of the opportunity may learn of the opportunity through a separate branch of the nodal tree having fewer or less onerous requirements. This encourages competition between any recipients to forward the digital objects as strategically as possible, thereby minimizing the amount, number and degree of connection values or other restrictions piled on top of the opportunity. It also strongly incentivizes recipients to forward the digital opportunity on to as many subsequent recipients as possible in the hopes of providing the shortest possible nodal branch between the originator and an eventual acquirer, a.k.a. the final recipient.

Thus, as will be appreciated by those skilled in the art, the system and method of the invention allows an originator of an opportunity to disseminate a notification and description of the opportunity in a highly targeted manner, specifically through networks of trusted individuals. Using the systems and methods of the present invention to disseminate an opportunity also minimizes the connection values demanded by each referral node, thereby minimizing the cost of disseminating the opportunity and locating an acquirer for the opportunity.

In one embodiment, the system and methods of the present invention may be facilitated by a platform specifically designed to practice the various aspects of the invention. Such a platform will allow any originator to generate a digital object describing an opportunity. The platform may utilize wizards or other software to assist an originator in developing an effective digital object as a highly effective and enticing brochure or information package. The digital object will be an either digital or printable, customizable “marketing” material for a physical object, service or other ends over which two parties may need to match most effectively. It may include all forms of media (text, images, video, audio etc). It will reside within an application, i.e. the platform, which will allow for the collection of data from the recipients. The platform or application may also host the digital object which may be accessed via the internet or other easily accessible network.

Once the digital object has been created by an originator, the platform will generate a link to the digital object. As used herein, the term “link” has a broader definition than merely a hyperlink. A link of the present invention may be a URL, QR code, system generated unique tag, serial number, or any real world or digital method of uniquely identifying the digital objects and/or opportunity and allowing a recipient of the link to readily review and assess the digital object.

The originator then sends this link to one or more first tier recipients. The originator may use the platform to accomplish this. For example, an originator may designate one or more phone numbers, email addresses, social media profiles (such as for example a Facebook® or Instagram® profile) or even physical address through which the link can be provided to a recipient so that they may view the digital object. The digital object may be printed and mailed to one or more recipients. In this case, the printed digital object may include a QR code, bar code, URL or other methods through which a recipient may access the options to either present an offer to the originator to acquire the opportunity and/or to forward the digital object to additional recipients.

When a recipient elects to make an offer to the originator, the platform itself, possibly using a wizard or other interactive software, obtains any information required by the originator to accompany such an offer. When a suitable offers is extended to the originator, the originator may elect to close the digital object and prevent further forwarding of the digital object and/or accepting offers from recipients. Once a match between an opportunity and a recipient making an offer occurs, the system can make the nodal tree or branch ledger public to the participants, i.e. all of the recipients in a branch of the nodal tree. If these participants desire to collect their connection values, the platform allows them to report or take other action in order to make sure that if the match occurred, the platform is aware of it. This inhibits the various members within a nodal branch or within the nodal tree generally from attempting to surreptitiously circumvent the nodal tree hierarchy so as to deny one or more referral node recipients their fee, i.e. their connection value.

To ensure the accuracy and validity of the various referring recipients in the various branches of the nodal tree, the platform may utilize a block chain ledger to track and map the nodal tree created through the principles of the invention. Such a block chain ledger may be a publicly distributed blockchain or a permissioned blockchain operated by the platform. In addition, block chain ledger's generally create a single string, i.e. a chain, of transactions. The block chain ledger of a platform facilitating the principles of the invention would differ from such a traditional block chain and include numerous branches that would not be automatically culled as is done with traditional cryptocurrency block chains.

An advantage of using a platform or application to facilitate the systems and methods of the present invention is that it would prevent one of the recipients forwarding the digital object from divulging information that could identify either the originator or one or more of the recipients through which the digital object has been forwarded. The platform itself would generate the notifications of the digital objects to the recipients selected for forwarding to. Optionally, an originator would have the ability to review any forwarding messages from the various recipients to ensure no unwanted information is included and may flag or block forwarding messages and/or recipients who have attempted to send identity divulging information to other recipients.

When a platform application is used to facilitate the systems and methods of the invention, the platform may also optionally include escrow functionality. For example, in originator may require that an offer made on the opportunity include a deposit placed in escrow. Similarly, a recipient acquiring the opportunity may desire that the platform hold any payments due in escrow until the opportunity has been fully transferred. The platform may also optionally provide additional functionality, such as running credit reports, preparing and filing loan applications and/or various due diligence activities for one or both of the originator and the recipient extending an offer.

Optionally, such a platform may also allow for business-to-business, or “back end” functionality that allows other organizations to incorporate systems and methods of the present invention into their own platforms and/or applications using the platform's APIs. For example, marketplaces, e-commerce platforms and social media platforms allow users to generate profiles, establish connections with other users, and create various lists. These platforms may optionally design a tool using the APIs of a platform configured to facilitate the systems and methods of the present invention to customize this nodal tree building process for its users. The systems and methods of the present invention may also be used to extend the reach of these various online platforms and even migrate various networking processes onto those platform seamlessly, as explained in the examples below.

Optionally, in originator may simply request a specific price to acquire the opportunity. The price need not be monetary. In such a situation, a recipient who desires to acquire the opportunity need only provide the required payment. The payment could be placed in the platform's escrow. The platform could also optionally automatically distribute/remit the payment according to the various fees designated by each of the recipients in the chain of referrals, i.e. branch of the nodal tree. The originator may also provide terms which a recipient must agree to prior to viewing the digital object. When a recipient uses the link to access the digital object, he or she is first presented with terms and conditions for viewing the digital object. Once a viewer agrees to those terms, he or she may view the digital object.

### Example 1

An originator in possession of an esoteric bond or other security which is not easily salable through traditional means, can represent the asset digitally via the system by generating a digital object describing it. The system then generates a link to the digital object. The originator distributes the opportunity link to a set of recipients. Those first-tier recipients may then pursue the acquisition of the security themselves by making an offer to the originator. Optionally, those recipients may also reshare, or forward the opportunity whith others who they believe might be interested acquirors. Each recipient can add a percentage transaction fee in advance of resharing so that, should an acquiror ultimately be found, each of the referral nodes (i.e. the subsequent recipients which preceded that recipient) will be entitled to their stated fee, i.e. their connection value.

### Example 2

A plastics extrusion company is aware of an opportunity for its products in China, but currently has no distributors or other connections in Asia. The plastics extrusion company, the originator, thus identifies an opportunity for a person or entity to join it in a joint venture into China. This originator then, using the platform, generates a digital object that describes in detail the nature of the business opportunity in China and the required skills, connections and abilities necessary for a partner in the joint venture. The platform generates a hyperlink to the digital object which is displayed on a webpage generated by the platform. The originator then emails five different persons, first-tier recipients, who either may be interested in partnering for the joint venture or who may know parties interested in such a joint venture. When one of the first-tier recipients clicks on the hyperlink, he or she is automatically directed to the webpage on the platform which displays the digital object. The webpage also includes “buttons” which may include, a button to decline the opportunity, a button to submit an offer to acquire the opportunity and a button to forward the opportunity to one or more other prospective acquirers.

If the first-tier recipient elects to submit an offer, the platform provides a number of form fields in a wizard for the first-tier recipient to fill out. Once the first-tier recipient has completed the online form via the wizard, that information is forwarded to the originator who may decide to accept the offer, reject the offer, propose a counter offer, etc. If the originator accepts the offer or proposes a counter offer, then the identity of the originator is revealed to the party presenting the offer. Otherwise, recipients are not aware of the identity of the originator.

If the first-tier recipient elects to forward the opportunity to a second tier, or subsequent, recipient, then the platform requests the email addresses for the subsequent recipients and any requirements, i.e. connection values, imposed by the first-tier recipient as compensation for forwarding the opportunity. The originator has the option to accept or reject the requirements imposed by the recipient forwarding the opportunity. The platform generates a new webpage, having a unique URL, for each recipient who elects to forward the opportunity to other subsequent recipients. In doing so, the platform associates the forwarding recipients and his or her requirements, i.e. connection values, with the digital object viewed via that newly generated link. This process repeats through his many iterations as necessary until the originator identifies a suitable entity to acquire the opportunity. For every iteration, new links to the digital objects are generated by the platform, and the various branches of the nodal tree are recorded using an internal block chain or other method. Because the platform generates new links at each referral node in the tree, it easily and accurately tracks all of the requirements from each of the recipients along a branch of the nodal tree. The originator also has the option of informing all of the members forming the nodes of a branch in the nodal tree when and if an offer from a subsequent recipient has been received and/or accepted.

### Example 3

A dating website allows users to generate profiles and search each other's profiles in the hopes of finding a match. The website may also optionally include its own algorithms for suggesting possible matches between profiles. However, the dating platform desires to allow its users or, more importantly, even third parties to suggest possible matches for its users. Using the APIs of a platform configured to practice the methods and systems of the principles of the invention, the dating website creates a tool which allows its users to create a unique QR code or hyperlink for use by a matchmaker. The user then provides this unique QR code or hyperlink to the matchmaker. The matchmaker in turn provides this to persons, who may or may not also have profiles on the same dating website, whom the matchmaker believes is well-suited for the dating site user. The persons receiving the hyperlink or QR code may then use it to access the original user's profile.

If an acceptable match is established between the original user and the person who received the hyperlink or QR code, the matchmaker may be credited with successfully providing the match. This credit to the matchmaker may take the form of points on a dating website system, and a rating as a matchmaker, or monetary compensation, depending upon how the dating website and its users choose to compensate a matchmaker.

If a person viewing the original user's profile is not interested in the original user, he or she may generate a new QR code or hyperlink associated particularly with that person, which they may then pass on to other persons who may be a good match. Because each potential matchmaker utilizes a unique hyperlink or QR code, the dating website is able to track the chain of persons viewing the profile, thereby generating a nodal tree. Persons can be motivated to refer possible matches to a user's profile by providing incentives for matchmakers.

One advantage of this to a dating website is that persons who are not user members of the dating website engage and interact with it. This encourages participation in the dating website, improving its visibility and viewership. It also effectively migrates real-world matchmaking to the dating website.

### Example 4

A job search website lists employment opportunities and resumes of people seeking employment. The job search websites may utilize the APIs of a platform configured to practice the systems and methods of the principles of the invention to generate various tools specific to the website. For example, a candidate looking for an employment opportunity can use a tool constructed in this manner to generate a digital object in the nature of a cover letter, CV, and/or resume. The tool will generate a QR code or other link for the candidate's digital object. This candidate may then disseminate the QR code to headhunters, employment agencies or simply people well-connected in a particular field. Each of the persons receiving the QR code notifies the candidate of certain requirements, a connection value, such as a finders fee, for locating an employment opportunity that matches the candidate, which will be due upon the candidate accepting employment. The candidate either agrees or declines, and the person or persons attempt to find a suitable position for the candidate. Each of these persons, a first-tier recipient, and subsequently uses the job search website to forward the digital object to a subsequent recipient. The originator may then accept or decline any fees or other terms set by the subsequent recipient. This process may be repeated until the candidate obtains employment. In the event that more than one string of recipients referred identifies the accepted employment position, the candidate can elect which branch of the nodal tree created through the principles of the invention to utilize for compensating the intermediary referrals between the candidate and the job opening. As explained above, this incentivizes headhunters and others to minimize their Finder fees and to maximize the number of employment positions to investigate to find employment for the candidate.

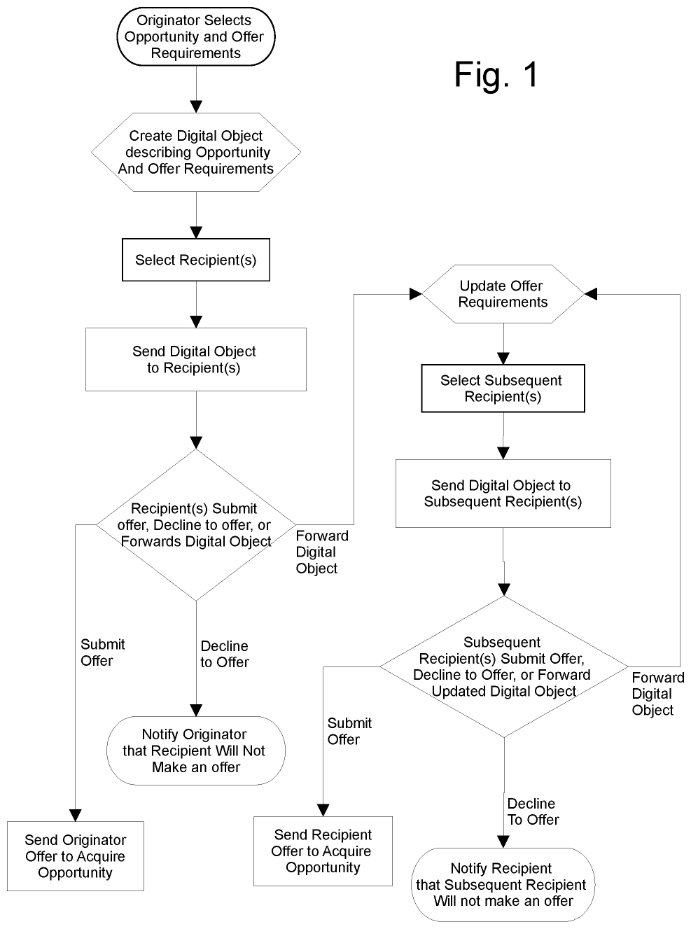

FIG. 1 shows a flowchart for a method of tracking dissemination of an acquisition opportunity 10 in accordance with principles of the invention. In the first step 12, the originator selects an opportunity available for acquisition and identifies features or characteristics required for a successful offer to acquire the opportunity from the originator. Using this information, the originator creates the digital object describing the opportunity and the offer requirements 14. This is usually done using an online platform. Next, the online platform generates a webpage 16 that displays the digital object and includes an offer submission option and an opportunity forwarding option. Typically, these options would be presented as buttons on the webpage. The platform also provide a link to the webpage which, as explained above, may be a URL, a QR code, a barcode or the like. The originator then sends this link to one or more recipients in step 18. In some embodiments, this may be accomplished by providing the recipients' email addresses to the platform which then sends email, text or voice notifications to the recipients.

The platform also associates the originator with the digital object, the webpage and the link 20 so that it may track the effectiveness of the originators invitations to recipients. This allows the platform to track and record viewing information for the digital objects. For example, the platform can record the number of times the originator's website is visited, as well as how many different locations visit the website. The website may optionally require anyone viewing the originator's generated webpage to provide an email address or other means of identification. Optionally, the platform may send an alphanumeric or other code with the email invitation, and require a recipient to enter the code in order to view the webpage. In this manner, the platform may more accurately track which recipients view the digital object, and how often each recipient returns to it.

Any recipients of the originator's invitation has at least two options when viewing the webpage, shown in step 22. A recipient viewing a webpage may select the “submit offer” option, for example by pressing a submit offer button displayed on the webpage. When the selection is made, the platform will require the recipient/viewer to fill out a form, answer various questions, and/or submit documentation or other information sufficient to satisfy the originator that this particular recipient/viewer is able to acquire and benefit from the opportunity described in the digital object. The number of recipients/viewers who submit an offer, and the number of acceptable offers submitted, may also be recorded by the platform as an additional type of viewing data.

A recipient may also elect to forward 28 the opportunity to someone else whom the recipient believes may be interested and qualified. When a recipient/viewer elects to forward the opportunity, the platform allows the recipient/viewer to add his or her connection value to the original digital object in order to create a new digital object that includes the connection value as one of the offer requirements in step 30. The platform will then generate a new webpage 32, different from the original webpage, which displays the new or updated digital object along with the offer submission and opportunity forwarding options. The platform will also provide a new link for the new webpage. The recipient, in this case referred to as a first-tier recipient as explained above, may then send this new link to additional, second-tier recipients in step 36. As with the originator sending a link in step 18, here are the first-tier recipient may send a link by providing email addresses phone numbers or other contact information to the platform itself, which then sends out notices or invitations to the second tier recipients. In addition, in step 36, the platform associates these first-tier recipients with the new updated digital objects, the new updated webpage, the new updated link, as well as the identities and contacts information for the second tier recipients if it has been provided. If the first-tier recipient does not use the platform to send invitations are notifications containing links, then the platform will instead identify recipients according to their VPNs or other information when they view the new updated webpage associated with the first-tier recipient.

These subsequent recipients, in this case the second tier recipients are provided the same two choices in step 38, to submit an offer or forward the opportunity, as the first tier recipients had in step 22. If a second-tier recipient elects to forward the opportunity, then steps 30, 32, 34, 36 and 38 are repeated for third tier recipients. Thus there can be fourth fifth sixth tier recipients ad infinitum, limited only by any conditions set by the originator or predetermined in the platform. The process will continue until the originator terminates the process or until a recipient submits an acceptable offer.

Finally, the platform ranks all of the recipients who participated in the above-described process. Recipients can be ranked according to the number of persons who viewed the opportunity as a direct result of a recipient's dissemination of the opportunity. One direct method of doing this is to document the total number of views for all original and/or updated digital objects that included a specific recipient's connection value. The platform can also identify a chain of recipients extending from the originator to the recipient that submitted an acceptable offer that was accepted by the originator.

The platform can be used by multiple originators for multiple opportunities a multiple number of times. Over time, the platform can document how often a particular recipient is part of a chain of recipients that led to an accepted offer to acquire the opportunity. These various recipients can thus be ranked from most to least likely to be included in a chain leading to an accepted offer. The recipients can also be ranked according to the total number of different viewers who view a digital object that includes that recipient's connection value. This total number of different viewers can be directly attributable to that particular recipient. Many websites, such as YouTube, Twitter and other social media sites typically rank influencers are contributors according to followers and/or views, but do not track or document which followers of an influencer are responsible for what percentage of total views. One benefit of the present invention is that it allows more accurate tracking of which recipients are responsible for how many of the total number of views.

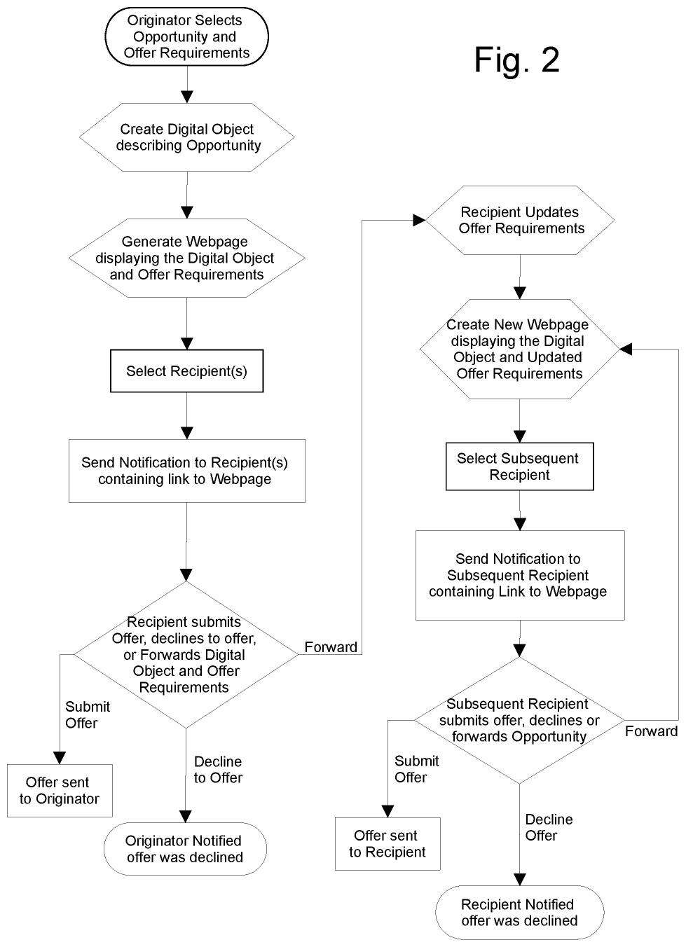

FIG. 2 shows a nodal tree 50 that illustrates the benefit of better understanding the relationship between viewers/recipients and total number of views. The originator 52 in this example sends invitations to view a digital object to four different recipients 60, 62, 64 and 68 in the first tier 54. These first-tier recipients forward the opportunity to second-tier recipients 56, who then forward the opportunity to third tier recipients 58. When viewing only the first and second tears 54 and 56, first-tier recipients 68 appears to be the most valuable because it has forwarded the offer to three second-tier recipients. First-tier recipient 62 appears to be the second most valuable because it has passed the opportunity on to two second-tier recipients. First-tier recipient 60 and 64 appear to be the least valuable because they only passed the opportunity on to a single second-tier recipient each. However, when the third tier recipients are considered, it can be seen that first-tier recipient 60 is actually the most valuable first-tier recipient because it has passed the opportunity along to a total of five additional recipients/viewers. First-tier recipient 62 is the least valuable because the two second-tier recipients did not pass the opportunity along to anyone. First-tier recipient 64 forwarded the opportunity on to a single second-tier recipient who passed along to two third tier recipients such that recipient 64 is responsible for three additional viewers of the opportunity. First-tier recipient 68, who had initially appeared to be the most valuable chose, poorly chose second-tier recipients because only one of them forwarded the opportunity to only a single third tier recipients. As additional tears are added to the tree, it becomes more apparent which recipients most effectively disseminate an acquisition opportunity. And even better picture of which recipients are most effective can be gleaned from considering several different nodal trees regarding different opportunities. The platform can collect this data and provided to originators, recipients and other parties so that they may better choose whom to forward an acquisition opportunity on two. Similarly, ranking recipients according to how often they are part of a chain that successfully located a recipient that submitted an acceptable offer can also aid in selecting the best recipients. The platform may also optionally rank originators and recipients according to different types of acquisition opportunities. For example, some recipients may be very effective at identifying persons to forward an opportunity on to win the opportunity is artwork, but not effective at all in identifying persons to forward an opportunity on to win the opportunity is a business acquisition.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A method for tracking dissemination of an acquisition opportunity comprising the steps of:
a) an originator creating a first digital object describing an opportunity available for acquisition, and minimum requirements for an acceptable offer;
b) an online platform generating a first webpage displaying the first digital object, and providing a viewer of the first webpage with an offer submission option and an opportunity forwarding option;
c) the platform providing the originator with a first link to the first webpage;
d) the platform associating the originator with the first digital object, the first webpage and the link; and,
e) the originator disseminating the link to one or more first-tier recipients;
f) one of the one or more first-tier recipients viewing the first webpage;
g) the platform recording viewing data for the first webpage;
h) when one of the one or more first-tier recipients selects the offer submission option, the platform requests offeror information and transmits an offer including the submitted offeror information to the originator; and,
i) when one of the one or more first-tier recipients selects the opportunity forwarding option:
the platform requests a connection value from the first-tier recipient;
the platform generates a second digital object by combining the first digital object and the connection value submitted by the first-tier recipient;
the platform generates a second webpage, associated with the first-tier recipient, which displays the second digital object, and provides a second offer submission option and a second opportunity forwarding option;
the platform provides the first-tier recipient with a second link to the second webpage;
the platform associates the second digital object, the second webpage, and the second link with the first-tier recipient; and,
the first-tier recipient disseminates the second link to one or more second-tier recipients;
the platform associates a total number of viewers of the second webpage with the first-tier recipient that selected the opportunity forwarding option;
j) repeating steps f) through i) until the originator accepts a submitted offer
k) for each recipient, the platform recording and ranking a total number of views of all digital objects which include each recipient's connection value.

2. The method for tracking dissemination of an acquisition opportunity of claim 1 wherein the platform further ranks recipients according to the number of times an offer is submitted and accepted for any digital object which includes that recipient's connection value.

3. The method for tracking dissemination of an acquisition opportunity of claim 2, further comprising the platform generating a recipient database and ranking recipients according to the total views attributable to each recipient, and the total accepted offers attributable to each recipient, and/or connection value.

4. The method for tracking dissemination of an acquisition opportunity of claim 3, wherein each of the recipients is categorized based on types of opportunities.

5. The method for tracking dissemination of an acquisition opportunity of claim 4, wherein the platform disseminates the links to the recipients.

6. The method for tracking dissemination of an acquisition opportunity of claim 5 wherein the opportunity is selected from the group consisting of a business for sale, a type of business which the originator wishes to acquire, an artwork for sale, and an artwork which the originator wishes to acquire.

7. The method for tracking dissemination of an acquisition opportunity of claim 6 wherein the originator remains anonymous until an offer is accepted.

8. The method for tracking dissemination of an acquisition opportunity of claim 7 wherein the originator must approve any recipient's connection value.

9. The method for tracking dissemination of an acquisition opportunity of claim 8 wherein connection values added to a digital object are not itemized.

10. The method for tracking dissemination of an acquisition opportunity of claim 9 wherein the platform constructs a nodal tree, wherein each recipient is a node and is connected to previous recipients and all subsequent recipients who view that recipient's digital object.
